(19) United States
(12) Patent Application Publication
(10) Pub. No.: US 2023/0306345 A1
(43) Pub. Date: Sep. 28, 2023

(54) ARTIFICIAL INTELLIGENCE SYSTEM FOR ANALYZING TRENDS IN SOCIAL MEDIA

(71) Applicant: Credera Enterprises Company (Texas Corp), Addison, TX (US)

(72) Inventors: Vincent Steven Yates, Copper Canyon, TX (US); Adrienne Jayne Arndt, Dallas, TX (US); Brian Craig Cumberland, Indianapolis, IN (US); Taronish Rajesh Madeka, The Colony, TX (US); Ashish Pujari, Chicago, IL (US)

(73) Assignee: Credera Enterprises Company (Texas Corp), Addison, TX (US)

(21) Appl. No.: 17/702,446

(22) Filed: Mar. 23, 2022

(51) Int. Cl. G06Q 10/06; G06F 40/295; G06Q 50/00

(52) U.S. Cl. CPC G06Q 10/06375; G06F 40/295; G06Q 10/06315; G06Q 50/01

(57) ABSTRACT

An artificial intelligence system configured to monitor, analyze, and identify trends in social media feeds in real-time, near real-time, or on a batch basis. The system identifies trends and anomalies in trends which may affect the financial or other performance of a company. The system finds likely causes for shifts and the probable result if the shift is not countered. The system includes novel algorithms for generating more accurate analysis and insights into the data.

### FIELD OF THE INVENTION

The present invention relates to the field of artificial intelligence (AI) systems and methods of improving the performance of predictive models utilizing such machines. More specifically, the use of AI systems to monitor and analyze the impact of social media feeds on a particular business or brand.

### BACKGROUND

The adoption of AI machine-learning is quickly becoming a major inflection point in human history. It has become a major disruptor in many industries and is reshaping the world around us. One of the many applications of AI is data analysis for the purpose of finding relationships linking data, such as correlation or causation. Understanding these relationships may be utilized to make predictions about the future.

For decades businesses have longed to understand how economic, social, or other events impact their financials (e.g., sales, growth, stock price). Traditionally, this analysis was retrospective and carried out by a person. For example, a company entering the second quarter may notice that its first quarter sales are lower than prior years. It may examine economic, social, and/or other factors seeking an explanation. This may require analyzing vast amounts of data and making educated guesses about what data might be relevant, how various pieces of data might be causing a loss of sales, and how best to mitigate that loss. In the information age, the data is not precious, but the ability to make sense of it is.

One growing concern for companies is the impact of social media on their financials. Social media has become a foundation of communications, cultural analyses, and change globally. Everything from countries and governments to brands and products are rising and falling because of social networks. In the business world, the impact of one tweet® or a five-second video clip can add or remove billions of dollars in value from an industry or company in a matter of days.

However, the volume of real-time (RT) communications (e.g., tweets®, Facebook® posts, Reddit® posts) and near-real-time (NRT) communications (e.g., blogs, TikToks®, YouTube® videos, Twitch® streams) is in the billions of posts per day and trillions in under a year. In the skin care industry alone, there are over 3.5 million hours of TikTok® videos, 2.5 billion Instagram® posts, and 11 million tweets® annually. Combing through these sources to find the handful of meaningful posts is only half the battle, coupling those posts to financial data to truly understand a post’s impact on a brand’s business is the other half of the battle, and is one aspect of the present invention.

Monitoring the vast quantities of social media feeds, tweets®, and blogs (i.e., the first half of the battle) is possible using AI and a vast amount of computing. Currently, many companies use social media listening tools such as Brandwatch®, Pulsar™, Mention™, and TweetDeck®. Typically, listening tools require the client to input tags, headlines, influencers, etc. that it wishes to search for, as well as, to define metrics. The client then hopes it used the right filters, the right metrics, and looks at the data at the right moment in time. In other words, the issue is that social media listening tools do not inform the client as to which data signals are important, the impact they may have, or when user interdiction is appropriate; it simply provides the data, any determinations are left to the client.

### SUMMARY OF THE INVENTION

The present invention is an AI system using scalable, cloud-based architecture and big data machine-learning and a set of methods that scans vast quantities of inputs and transforms data into information from which insights are derived. Current social media listening tools lack the crucial step of providing insights. Insights are what companies need to react with speed and effectiveness to the real-time opportunities and threats presented in the social sphere. Insights such as identifying the optimum time to react to negative posts by key social influencers, and optimizing marketing spent on social media (e.g., appropriate channels, messaging, influencers, etc.). The insights are based on identifying and understanding data trends and data anomalies. Data and information are everywhere, whereas insights are few and far between.

More specifically, the present system can dive deep into data structures to enrich existing feeds for new analysis centered on users, influencers, and associated and derivative communities on social media. The system can then analyze validated metrics across demographic and sociographic measures to determine brand audience engagement and changes (and their causes) in audience perceptions in RT or NRT.

Embodiments of the present invention provide an AI and machine-learning service that can be delivered in RT or NRT to a user through networked servers. The methods are typically implemented with AI executed on computer apparatuses and delivered to non-transitory storage mediums, to providers who then sell services, or to clients who utilize the service directly. While some of these methods are known, the present invention provides improvements to these known methods, as well as new methods relating to the identification of anomalies and their likely causes. More particularly, the present invention provides a methods for correlating social media data to business data to provide the client with a causal understanding of the likely impact of particular social media data on the client’s financials.

### BRIEF DESCRIPTION OF THE DRAWINGS

Embodiments will be readily understood by the following detailed description in conjunction with the accompanying drawings. Embodiments are illustrated by way of example, and not by way of limitation, in the figures of the accompanying drawings.

FIG. 1 is simplified block diagram illustrating a method, described herein according to an embodiment, which incorporates and uses the present invention which is suitable for implementation on an AI system.

FIG. 2 is simplified block diagram illustrating an AI system using scalable, cloud-based architecture and big data machine-learning with a method, described herein according to an embodiment, that scans social media data, transforms data into information, and transforms information into insights.

FIGS. 3 and 4 is simplified block diagram illustrating using an AI system and method, described herein according to embodiments, which incorporates the present invention, that combines financial data with social media data for the purpose of correlating financial performance to social media activity.

### DETAILED DESCRIPTION

The disclosed embodiments include examples of various social media platforms. These examples should not be taken as limiting, as the disclosure contemplates all such available platforms including equivalent platforms that are developed in the future.

The present invention monitors social signals (e.g., forum posts, Instagram® posts, a tweet®, a Facebook® post, LinkedIn® posts) for the mention of key terms (e.g., product, brand), but unlike existing social media monitoring systems, the present invention identifies which signals are important and when end user intervention is appropriate (alternatively, intervention may be automated). One way in which the present invention does this is through detecting anomalies in the data signals. For example, identifying an unusual change in the number of signals mentioning a particular brand coupled with an increase in the percentage of negative sentiment in the signals (e.g., a sudden increase in people making negative posts about Brand X). Moreover, the present invention uses methods for determining the probable cause of an anomaly (e.g., a social media influencer tweeted a complaint about Brand X’s political funding). The present invention can also be used to forecast the financial impact of the anomaly on the company (assuming company inaction). These insights can then be used by Brand X’s company to take mitigatory action before the anomaly impacts the company financially.

The system and methods of the present invention can include, incorporate, or operate in conjunction with or the environment of a machine-learning system which includes an AI computing architecture that is trained. The overall method described is novel and improvements to existing methods used to carry out individual steps of the overall method have been improved.

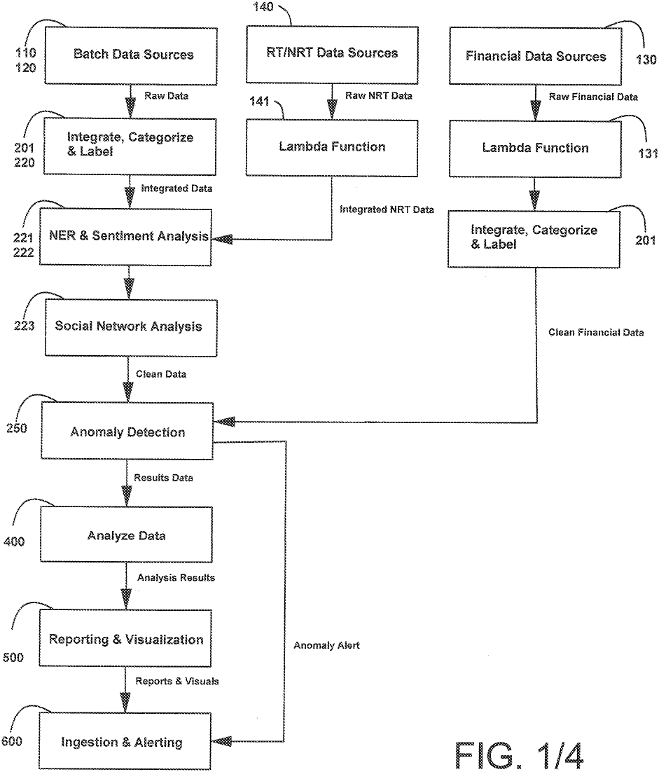

FIG. 1 is simplified block diagram illustrating a method, described herein according to an embodiment, which incorporates and uses the present invention which is suitable for implementation on an AI system. The description is in the context of an implemented AI system.

### Data Extraction

The system collects data from external data sources 110, such as social media sites (e.g., Facebook®, LinkedIn®, Tik Tok®, Twitter®, Instagram®, Reddit®, You Tube®), social media monitoring systems (e.g., Brandwatch®), the internet (e.g., Google Search®), and others (e.g., Keyword Tool®). The system also may collect data from the client which may include search terms, social media monitoring systems (e.g., Brandwatch®) employed by the client 120, as well as financial data from other systems employed by the client (e.g., Nielsen®, IRi® (Information Resources, Inc.)) 130. The batch data 110, 120, 130 may be extracted on a scheduled basis and stored, preferably virtually in a raw data bucket. As one skilled in the art will appreciate, the databases searched, and the data collected will vary based upon the objectives, costs, availability, and legal restrictions.

If latency is of particular concern, an optional Lambda architecture may be employed. When processing large amounts of data, there is usually a delay between data collection and data reporting. Often some of that delay is created by data validation and/or granulizing the data. Sometimes avoiding latency outweighs being certain of the data’s validity and/or its granulation. In such cases the use of a Lambda architecture may be used.

Lambda architecture is a data-processing architecture integrating batch 110, 120, 130 and RT/NRT data 140 within a single framework. This approach strikes a balance between latency, throughput, and fault-tolerance. Batch processing provides comprehensive and accurate views, while RT/NRT stream processing provides a faster, but possibly less accurate view. The two outputs may be joined before presentation. The Lambda architecture and path for RT/NRT data sources 140 are discussed separately below.

### Data Transformation & Storage

Data integration involves data cleansing that includes de-duplication, incomplete data management, attribute standardization, and changing the data structures (e.g., into an OLAP model). Integration facilitates easy querying of data. For example, transforming 280 characters tweets®, forums, Tik Tok® video, or other social signals into processible, meaningful data. The integrated data may then be analyzed to determine what the data is referencing (e.g., person, place, thing) (named entity recognition or NER); what about that entity is being discussed (topic); and whether the reference is positive, negative, or neutral (sentiment analysis). The system then analyzes to what extent the social signal is infecting a broader community (social network analysis).

A data integration service (e.g., Glue®, ECS®, EMR®) 201 may be used to carry out the data integration which involves multiple tasks, such as discovering and extracting data from various sources; transforming the data into a processing form; and loading and organizing data in databases, data warehouses, and data lakes (collectively, ETL). Data integration may also include enriching, cleaning, normalizing, and combining data. The data is usually categorized and labeled 220. The metadata (e.g., table definition and schema) associated with the processed data may also be stored in the data integration service to make it available for queries by downstream analytics services 400. In the case of NRT data 140, ETL may be carried out as part of the Lambda function or streaming application (e.g., Spark™ Streaming, Flink®) 141.

In addition to integration, the data 110, 120, 140 is subjected to a series of analysis using a distributed analytics engine for large-scale data processing (e.g., Apache Hadoop®, Apache Spark™ (“Spark™”)). (Financial data 130 can optionally bypass this analysis, and once integrated, flows to the anomaly detection step 250). NER 221 is used to identify what that the data is referencing (e.g., person, place, thing). Sentiment analysis 222 is used to determine whether the reference is positive, negative, or neutral. The system then analyzes to what extent the social signal is affecting a broader community (social network analysis) 223.

Social network analysis (SNA) is the study of social structures using networks and graph theory. A network has two basic components: nodes and edges. Nodes represent the participants in the network, and edges represent the connections between the nodes (participants). Properties associated with nodes and edges such as a node’s degree and an edge’s weight can provide additional context and highlight important areas of the network.

Thus, SNA may utilize Twitter® data to highlight important connections between consumers, influencers, and brands. Social media mentions, likes, and comments may be analyzed to identify the brands and influencers with the most connections to consumers. The constructed network highlights the most successful influencers and their brand partners. High-impact influencers without brand partners are identified as potential targets for partnership, whereas, low-impact influencers are identified for potential removal.

Once all the signals across all the social media channels are gathered and transformed into clean data, a variety of statistical analysis (in the class of anomaly detection) is conducted to determine whether these signals are in the bounds of day-to-day noise or are indicative of a change taking place in the market 250. Anomaly detection identifies deviant patterns. If a topic’s social media performance deviates significantly from its model’s forecast, an anomaly is detected, and alert is sent (see 600). Anomaly detection may also be carried out on the clean financial data which originated from financial data sources 130.

### Analytics

A variety of tools are available for analyzing the results data 301 and historic data 302. The client may use a Hadoop-based stream processing application for analytics, such as Spark Streaming® on Amazon EMR®. Data analysis may also be performed using services like Amazon Athena®, an interactive query service, or Spark®. The analysis reveals trends which using causal inferential modeling may correlate to the client’s financial data.

### Reporting / Visualization and Alerting

The results from data analysis 400 may be reported and/or visualized (e.g., graphs, charts) 500. Many business-intelligence (BI) tools provide data visualization, reports, and dashboards (e.g., QuickSight®, PowerPoint®).

The analysis and any anomalies may be ingested by the data scientists, marketing firms, and ultimately, the client 600. Marketing firms such as RAPP®, Sparks & Honey®, Targetbase®, and Javelin® may be employed by the client to aid in ingestion of data and developing strategies to mitigate or leverage changes in social media. Alternatively, or in addition to, an AI system may be used to ingest the analysis in whole or in part. Ultimately, the ingestion may be purely informative or trigger further actions by the client or system provider. For example, a client may need to take action to mitigate a growing negative public sentiment, or the system provider may need to conduct further data analysis to determine the likely causes and predicted effect of an anomaly.

### RT/NRT Data Extraction

When processing large amounts of data, there is usually a delay between data collection and data reporting. Often some of that delay is created by data validation and/or granulizing the data. Sometimes avoiding latency outweighs being certain of the data’s validity and/or its granulation. In such cases, Lambda architecture may be used. Lambda architecture is a data-processing architecture integrating batch and RT or NRT data within a single framework. This approach strikes a balance between latency, throughput, and fault-tolerance. Batch processing provides comprehensive and accurate views, while RT/NRT stream processing provides a faster, but possibly less accurate view. The two outputs may be joined before presentation.

Data integration tools like Kinesis®, Firehose™, Spark™ Steaming, and Flink® allow for RT/NRT transformation and analysis. The batch data 110, 120 and RT/NRT data 140 are ingested together, usually in parallel, to create a view of the entire dataset which can be aggregated, merged, or joined, and eventually stored in a data bucket. For the batch layer, historical data can be ingested at any desired time interval (e.g., daily). For the speed layer, the fast-moving data must be captured as it is produced and streamed for analysis. Once the speed layer is transformed into clean data, it may be warehoused 300, analyzed 400, and reported 500, in much the same way as batch 110, 120.

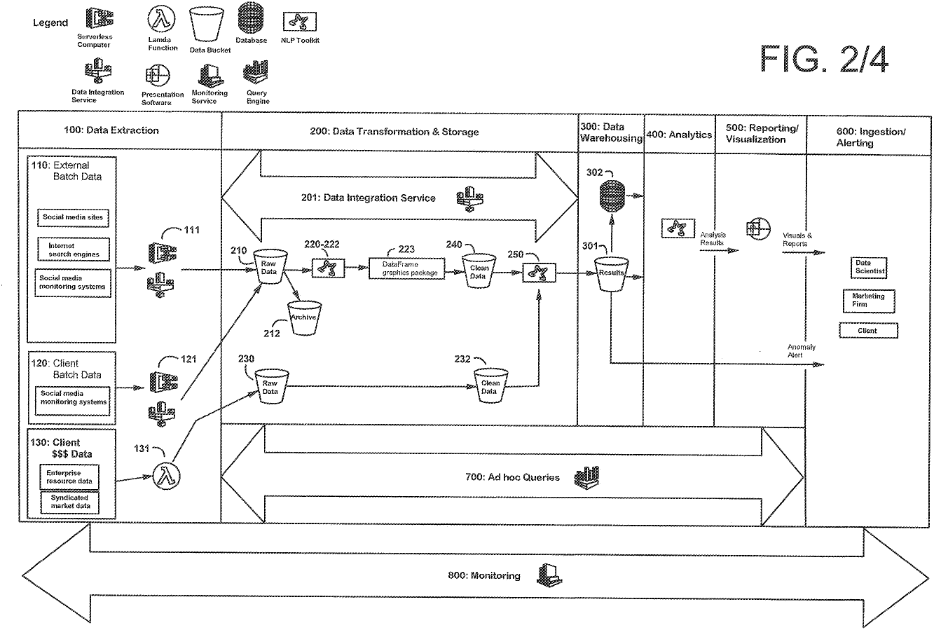

FIG. 2 is simplified block diagram illustrating an AI system using scalable, cloud-based architecture and big data machine-learning with a method, described herein according to an embodiment, that scans social media data, transforms data into information, and transforms information into insights. FIG. 2 is based upon a specific embodiment using exemplary devices, servers, and/or software components that operate to perform various methodologies in accordance with the described embodiment. One skilled in the art would appreciate that the devices, servers, and/or software components may be combined or separated for a given embodiment and may be performed by a greater or fewer number of components.

### Data Extraction 100

The system collects batch data from external data sources 110 including social media sites (e.g., Tik Tok®, Twitter®, Instagram®, Reddit®, You Tube®), social media monitoring systems (e.g., Brandwatch®), and internet search engines (e.g., Google Search®). The system also collects data 120 from the client or systems employed by the client such as search terms and data from social media monitoring systems (e.g., Brandwatch®, Nielsen®, IRi®) engaged by the client. The batch data 110, 120 is gathered on a scheduled basis via a data integration service (e.g., Glue®) in conjunction with a serverless computer (e.g., Amazon ECS®) 111, 121 and stored in a data bucket (e.g., Amazon’s Simple Storage Service® or “S3”) 210.

Likewise, client financial (abbreviated as “$$$” in FIG. 2) data 130 can be extracted and loaded via a Lambda function 131. This data path is described separately below. Financial data may be obtained from a provider of syndicated market data such as SPINS®, Nielsen®, and IRi®, however, the data could also be extracted from the client’s ERP (enterprise resource planning) or a manual data dump in the form of csv (comma separated values) or equivalent (e.g., JSON, JavaScript Object Notation).

As latency is not of particular concern for this embodiment, a Lambda function 141 is not employed to process RT/NRT data 140, as it was in FIG. 1.

### Data Transformation & Storage 200

The raw data in bucket 210, gathered from sources 111 and 121, is archived 212 and integrated using a data integration service(s) (e.g., EMR® and Apache® Airflow) 201. In the case of video (e.g., TikTok), the video must be converted into text using a speech to text solution. An object detection algorithm may be used to identify products and other objects shown in the video. Likewise, an optical character recognition (OCR) may be used for any text that is written in the video. Lastly, it may be of interest to identify and make note of background music for analysis.

The integrated data may then be processed 220-222 to determine what that the data is referencing (e.g., person, place, thing) (NER) 221; what about that entity is being discussed (topic) 221; and whether the reference is positive, negative, or neutral (sentiment analysis) 222. The system then analyzes to what extent the social signal is infecting a broader community (social network analysis) 223. Such processing (i.e., 220-222) may be performed by a natural language processing (NLP) library and/or toolkit, offered under various tradenames (e.g., Spark™-NLP, TextBlob, SpaCy, Gensim).

### Named Entity Recognition (NER) Analysis 221

More specifically, the integrated data originating from bucket 210 is categorized and labeled 220 by an NLP toolkit (e.g., Spark™) and initially analyzed. See also FIG. 1. The initial analysis consists of the NLP toolkit identifying whether the social signal (e.g., a tweet or post) references a person, place, organization, etc. 221. This may be done using named entity recognition (NER) algorithms using models based on grammar and/or statistics. NER is a task in which a model is asked to predict which tokens in a text represent named entities. Often, the model additionally outputs ontological labels categorizing entities (e.g., organizations, products, people, locations, etc.) which may be useful in downstream analyses (e.g., creating auto-updating dictionaries of relevant entitites).

The initial data analysis may also determine what about the entity is being discussed (the topic) 221 and whether the reference is positive or negative (the sentiment) 222. Once the social signal is understood (e.g., a negative reference to Coke®), it is analyzed to determine whether the message/thought is infecting the broader community (community analysis) 223. The resultant, clean data is stored in a data bucket 240.

### Sentiment Analysis 222

NLP libraries are usually pre-trained using specific datasets. For example, Spark™-NLP was trained using Twitter® and IMDb® open-source data sets. Thus, Spark™-NLP tends to view data as being in one of two categories, “Twitter-like” or “review-like” which fails to account for nuanced sources which may be a mix of the two types. In addition, Spark™-NLP analyzes “review-like” data using a majority vote heuristic which fails to evaluate salience of individual sentences within the review.

The inventors have found a method of mitigating some of the shortcomings of Spark™-NLP and other similarly pre-trained NLP libraries. For example, splitting reviews into sentences to allow a more fine-grained analysis. Also using bidirectional encoder representations from transformers (BERT) to further train NLP’s sentiment analysis models allows fine tuning. BERT used in conjunction with NLP provides the AI system with a more contextual language understanding. For example, an NLP analysis might conclude that the word “cake” generally has a positive sentiment associated with it. By using BERT, the AI system can learn that the word “cake” in the context of cosmetics, generally has a negative sentiment associated with it. Thus, the combination of NLP with BERT provides a more contextual and meaningful sentiment analysis.

### Social Network Analysis (SNA) 223

Social network analysis (SNA) is the study of social structures using networks and graph theory. A network has two basic components: nodes and edges. Nodes represent the participants in the network, and edges represent the connections between the nodes (participants). Properties associated with nodes and edges such as a node’s degree and an edge’s weight can provide additional context and highlight important areas of the network. Commonly, this data organized into a two-dimensional table or rows and columns, much like a spreadsheet, referred to as a DataFrame.

Thus, SNA may utilize Twitter® data to highlight important connections between consumers, influencers, and brands. Social media likes, comments, followers, and posts are analyzed to identify the brands and influencers with the most connections to consumers. The constructed network can highlight the most successful influencers and/or their relationships to brand partners. SNA may be carried out on available AI tools such as a DataFrame-based graphics package available under the tradename GraphFrames® 223.

### Anomaly Detection 250

Once all signals across all channels are gathered and transformed into clean data 240, 232 a variety of statistical analysis (e.g., causal inferential modeling) is conducted using an NLP toolkit (e.g., Spark™) to determine whether these signals are in the bounds of day-to-day noise or are indicative of a change taking place in the market 250. Anomaly detection identifies deviant patterns. If a topic’s social media performance deviates significantly from its model’s forecast, an anomaly is detected, and alert is sent (see 600).

Anomaly detection may also be performed on clean financial data 232 which originated from client financial data 130. In the embodiment of FIG. 2, the client provides financial data 130 obtained from syndicated market data suppliers (e.g., Nielsen® tracking in-store purchase behavior and IRi® tracking on-line purchasing behavior), as well as, internal financial information from the client’s enterprise resource data. The client financial data 130 can be analyzed for anomalous changes 250 (e.g., dramatic fall off in purchasing). If appropriate, an alert may be sent out to spur client action and/or additional analysis to identify the likely cause(s) of the anomaly 600. Apprising users of the causes behind detected anomalies can inform future strategies and allow insight into what’s working best for their competitors.

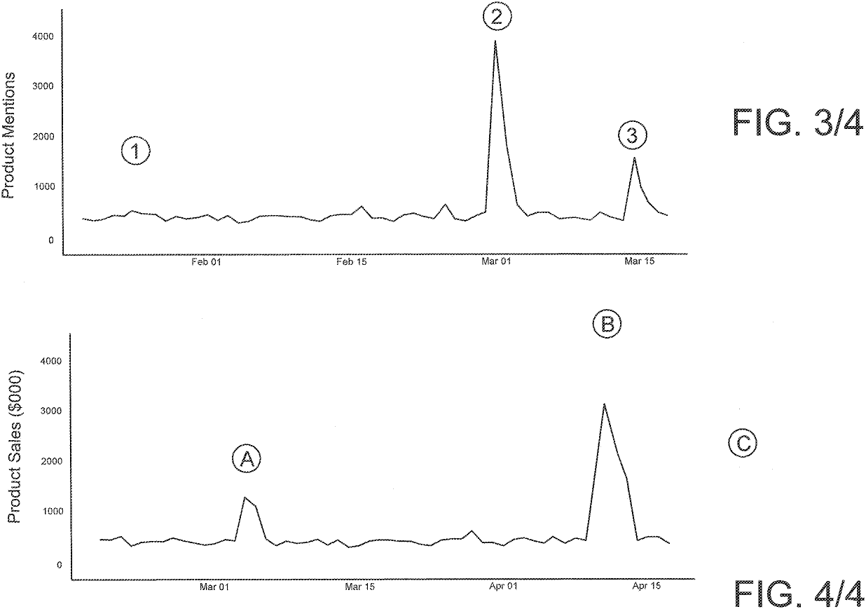

An inventive aspect of the present AI system is the use of client financial data 130 to inform anomaly detection 250 and provide client insights. FIGS. 3 and 4 depict an example of this. FIG. 3 depicts two anomalous spikes (2 and 3) in the mention of a particular product on social media feeds (in this example with positive sentiment). FIG. 4 depicts sales data for the product of interest. By comparing both sets of data, an increase in sales at point B is attributable to the increase in social media mentions at point 2. A comparison of the dates reveals that in this example there is approximately a 5-week delay between the increase in social media mentions and the increase in sales. The comparison also shows an increase in sales at point A, but no corresponding increase in product mentions. As there should be a corresponding increase approximately 5 weeks prior to the increase in sale (i.e., around point 1), the AI anomaly system can be retrained to find the corresponding increase. The AI system may accomplish this by analyzing additional search terms or modifying the various weights it used in its original analysis. Moreover, FIG. 3 shows an increase in product mentions around March 15 (point 3). A forecast of increased sales around April 15 (point C) can be made. Additionally, a prediction regarding the size of the increase can be made, based upon the size of the increase at point 3.

By combining an analysis of financial data 232 with social media data 240, the social media sources resulting in changes in sales data may be traced. In addition, accurate forecasts can be made about the likely impact of anomalies in social media on financials. Lastly, this combination can be used to modify the AI analysis of the social media data to better account of changes in financials.

### Data Warehousing 300

All the results from the data transformation and anomaly detection may then be stored 301 or virtually warehoused 302 for proper analysis 400 and reporting/visualization 500. The data warehoused in database (e.g., Amazon’s DynamoDB) 302 may provide important information for future use and/or modeling modifications.

### Analytics 400

Data analysis 400 is performed on the results data stored in data bucket 301, as well as historic data warehoused in a virtual database 302. Analysis is primarily performed in an NLP toolkit (e.g., Spark™) which is designed for high-performance, big-data analysis, however, supplementary tools found in programming languages Python® and RStudio® can be used for ad hoc investigations or deep-dive investigations usually carried out manually.

Data analysis may include answering ad hoc questions about a particular marketing campaign, influencer or post that may not have been an anomaly, or by digging deeper into the cause or effect of an anomaly. For example, in the summer of 2021 a spike in the search volume for CeraVe® moisturizing cream skyrocketed with a corresponding rise on TikTok®, but no particular video was driving the anomaly. In that case, digging deeper into the data through EDA (exploratory data analysis) found a macro theme for Neutrogena® and a myriad of other sunscreens which were recalled because of benzene contamination. No one person or post drove the volume, but rather everyone was saying something about it. CeraVe® sunscreen as not implicated in the benzene scare and thus, benefitted.

### Reporting / Visualization 500 and Alerting 600

The results from data analysis 400 may be reported and/or visualized (e.g., graphs, charts) 500 using presentation software such as that sold under the tradenames PowerPoint®, Jupyter® and Superset®. Also, programming languages like Python®, RStudio® can be used to create custom-made reporting and visualization, depending upon specific needs.

The visuals and reports, as well as any anomalies may be ingested by the data scientists, marketing agents, and/or the client 600. Alternatively, or in addition to, an AI system may be used to ingest the analysis. Ultimately, the ingestion may be purely informative or trigger further actions by the client or system provider. For example, a client may need to take action to mitigate a growing negative public sentiment, or the system provider may need to conduct further data analysis to determine the likely causes and predicted effect of an anomaly.

### Query Layer 700 and Monitoring 800

All stages may have a variety of monitoring/logging/anomaly detection in place (see e.g., 700, 800). For example, if data collection 111 or 121 does not begin at the scheduled time, an exception error may be triggered. Likewise, if the amount of data collected or the time spent collecting the data, falls outside of projections, an alert may be triggered. As one skilled in the art would appreciate, these principles can be applied to all steps in the process. Monitoring services are available under the tradenames CloudWatch, WhatsUp Gold, and SolarWinds.

Moreover, ad hoc queries may be submitted at various steps in the process to help check the integrity and accuracy of the system 700. Queries help to eliminate unwanted data elements from the downstream bucket. Also, having a view of upstream source data aids in developing more targeted analytical applications downstream. A variety of query engines may be used and are available under the tradenames Firebolt, Presto, Apache® Drill, Amazon® Athena, and BigQuery.

### Client Financial Data Path

In FIG. 2, client financial data 130 may be collected in a batch process via a Lamba function . The raw financial data is stored in data bucket 230 and once cleaned stored in bucket 232. Unlike the external and client batch data 110, 120, the client financial data 130 need not be subjected to sentiment and social network analysis 220-222. The clean financial data 232 undergoes anomaly detection 250 along with the clean data 240 originating from the external batch data 110 and client batch data 120. From that point 250 forward, the data path for the financial data 130 is the same as that for the other batch data 110, 120.

Where applicable, various embodiments provided by the resent disclosure may be implemented using hardware, software, or combinations of the two. Also, where applicable, the various hardware and/or software components set forth herein may be combined into composite components comprising software, hardware, and/or both without departing from the spirit of the present disclosure. Where applicable, the various components may be separated into sub-components without departing from the scope of the present disclosure. In addition, where applicable, it is contemplated that software components may be implemented as hardware components and vice-versa.

Software, in accordance with the present disclosure, such as program code and/or data may be stored on one or more computer readable mediums. It is also contemplated that software identified herein may be implemented using one or more computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some feature of the embodiments may be employed without a corresponding use of other features. One of ordinary skill in the art would recognize many variations, alternative, and modifications of the foregoing disclosure. Thus, the scope of the present application should be limited only by the following claims, and it is appropriate that the claims be construed broadly and, in a manner, consistent with the full scope of the disclosure.

What is claimed is:

1. A method to analyze social media content comprising the steps:
extracting representative data from at least one social media feed;
integrating said representative data into integrated data by normalizing its structure such that the integrated data is readily processible;
conducting name entity recognition analysis on said integrated data to identify the brand or product being discussed in the social media feed;
conducting sentiment analysis on said integrated data to determine whether the social media feed is of a positive, negative, or neutral sentiment;
conducting social network analysis on said integrated data to identify connections between consumers, influencers, products, and/or brands;
storing data from all said analyses as clean data; and
conducting an anomaly analysis on said clean data and storing results data; and
analyzing said results data to predict impact of the social media feed on brand or product.

2. The method of claim 1 wherein the step of conducting sentiment analysis further comprises using a natural language processing library.

3. The method of claim 2 wherein the step of conducting sentiment analysis further comprises using bidirectional encoder representations from transformers.

4. The method of claim 1 further comprising sending an alert when an anomaly is detected.

5. The method of claim 1 wherein the step of extracting representative data is done in batch.

6. The method of claim 5 wherein NRT data is continually extracted from said social media feed at times after the batch data has been extracted.

7. The method of claim 6 further comprising: combining said batch data with said NRT data prior to the step of conducting anomaly analysis.

8. An artificial intelligence system, configured to analyze social media content comprising:a processor and a computer readable medium operably coupled thereto, the computer readable medium further comprising a plurality of instructions stored in association therewith that are accessible to, and executable by, the processor, to perform modeling operations which comprise:
extracting and storing batch data from a social media stream;
integrating said batch data into readily processible data;
conducting name entity recognition, sentiment, and social network analysis on said processible data;
storing clean data from said analyses;
extracting, integrating, and storing financial data from a client;
using AI anomaly detection to identify anomalies in clean data and storing results and results data; and
using causal inferential modeling to correlate said anomalies with said financial data.

9. The system of claim 8 further comprising:
conducting an anomaly analysis on said clean data and storing results data; and
analyzing said results data to predict impact of the social media feed on brand or product.

10. The system of claim 9 further comprising:
using said correlation to predict effects of future anomalies.

11. The system of claim 10, wherein the predicted affects include an approximate date by which the future anomaly will affect future financial data.

12. The system of claim 9 further comprising:
identifying large changes in said financial data which have no correlating anomaly in said clean data; and
utilizing said uncorrelated financial data to retrain said AI anomaly detection.

13. The system of claim 9 further comprising extracting and storing NRT raw data at a time after said batch data was extracted.

14. The system of claim 10 further comprising extracting and storing NRT raw data at a time after said batch data was extracted.

15. A computer useable medium having computer readable program code embodied therein, said code adapted to be executed on an AI system to implement a method for analyzing social media content, the method comprising:
extracting batch data from a plurality of social media sources;
extracting NRT data from a plurality of social media sources after the batch data has been extracted;
transforming said batch data and said NRT data into integrated data;
conducting name entity recognition, sentiment, and social network analysis on said integrated data;
storing clean data from said analyses;
extracting, integrating, and storing financial data from client as clean financial data;
identifying anomalies in said clean data;
correlating said anomalies with said clean financial data; and
using said correlation to predict effects of future anomalies.

16. The system of claim 15, wherein the predicted effects include an approximate date by which the future anomaly will affect future financial data.

17. The system of claim 15 further comprising:
identifying large changes in said clean financial data which have no correlating anomaly in said clean data; and
utilizing said uncorrelated clean financial data to modify anomaly detection.

18. The system of claim 15 further comprising:
using ad hoc queries at various steps in the process to check the integrity and accuracy of the system.

19. The method of claim 15 wherein the step of conducting sentiment analysis further comprises using bidirectional encoder representations from transformers.

20. The method of claim 19 wherein the step of conducting sentiment analysis further comprises using a natural language processing library which has been retrained using bidirectional encoder representations from transformers.
